(19) United States
(12) Patent Application Publication
(10) Pub. No.: US 2015/0089864 A1
(43) Pub. Date: Apr. 2, 2015

(54) RAISED BED GARDEN WALL SYSTEM

(71) Applicant: Peter B. Aronow, East Hampton, NY (US)

(72) Inventor: Peter B. Aronow, East Hampton, NY (US)

(21) Appl. No.: 14/504,196

(22) Filed: Oct. 1, 2014

Related U.S. Application Data
(60) Provisional application No. 61/885,450, filed on Oct. 1, 2013.

(51) Int. Cl. A01G 1/08; A01G 9/02

(52) U.S. Cl. CPC A01G 1/08; A01G 9/02
USPC 47/33

(57) ABSTRACT

A raised bed garden system has a plurality of panels that can be designed in any size and shape. The panels can be pre-formed in various sizes and can be joined together by various types of couplings to make larger sizes. The panels can have hollow insertion members on at least the top and bottom edges thereof to allow the couplings to interconnect the panel pieces,

### CROSS-REFERENCE TO RELATED APPLICATIONS

This application claims the benefit of U.S. provisional patent application No. 61/885,450, filed Oct. 1, 2013, the contents of which are herein incorporated by reference.

### BACKGROUND OF THE INVENTION

The present invention relates to raised bed gardens and, more particularly, to panels and connectors for creating raised bed gardens of various sizes and shapes.

Raised bed gardening is popular for many reasons. These gardens can be particularly helpful to limit the spread of weeds, create a define space for the garden, and allow high quality soil be placed within the raised bed for growing flowers and vegetables, for example.

Many raised bed gardens are formed from wood, such as 2×4 and 2×8 planks, 4×5 logs, railroad ties, or the like. The user has to stack and secure these wood products together to keep the garden intact. Moreover, over time, the wood structure can break down, especially with repeated watering.

As can be seen, there is a need for an improved raised bed garden wall system.

### SUMMARY OF THE INVENTION

In one aspect of the present invention, a raised bed garden system comprises a plurality of side panels; receptacle portions disposed along at least an upper edge and a lower edge of the plurality of side panels; coupling members joining adjacent ones of the plurality of side panels, the coupling members including insertion members extending from each side thereof at an upper side and a lower side thereof, wherein the insertion members of the coupling members fit into the receptacle portions of the plurality of side panels to securely join the adjacent ones of the side panels.

In another aspect of the present invention, a raised bed garden system comprises a plurality of side panels; receptacle portions disposed along at least an upper edge and a lower edge of the plurality of side panels; corner coupling members joining adjacent ones of the plurality of side panels at an angle, the corner coupling members including insertion members extending from each side thereof at an upper side and a lower side thereof; and straight coupling members joining adjacent ones of the plurality of side panels in a substantially straight line, the corner coupling members also including insertion members extending from each side thereof at a straight coupling member upper side and a straight coupling member lower side thereof, wherein the insertion members of the straight and the corner coupling members fit into the receptacle portions of the plurality of side panels to securely join the adjacent ones of the side panels.

These and other features, aspects and advantages of the present invention will become better understood with reference to the following drawings, description and claims.

### BRIEF DESCRIPTION OF THE DRAWINGS

FIG. 1 is a perspective view of a raised garden system, partially assembled, according to an exemplary embodiment of the present invention;

FIG. 2 is a perspective view of a corner coupling member of the raised garden system of FIG. 1;

FIG. 3 is an end view of the corner coupling member of FIG. 2;

FIG. 4 is a perspective view of the corner coupling member of FIG. 2, installed onto a side panel;

FIG. 5 is a perspective view of a straight coupling member of the raised garden system of FIG. 1;

FIG. 6 is an exterior view showing two panels of the raised garden system, joined together in a straight line with the straight coupling member of FIG. 5; and

FIG. 7 is a perspective view of a corner coupling member according to an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a raised bed garden system having a plurality of panels that can be designed in any size and shape. The panels can be pre-formed in various sizes and can be joined together by various types of couplings to make larger sizes. The panels can have hollow insertion members on at least the top and bottom edges thereof to allow the couplings to interconnect the panel pieces, as described in greater detail below.

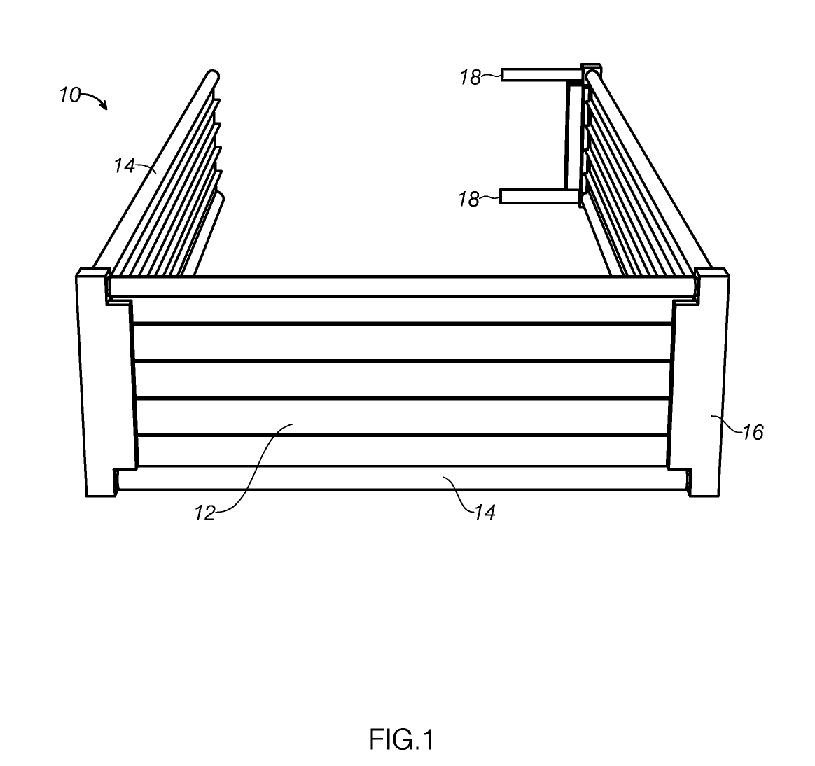

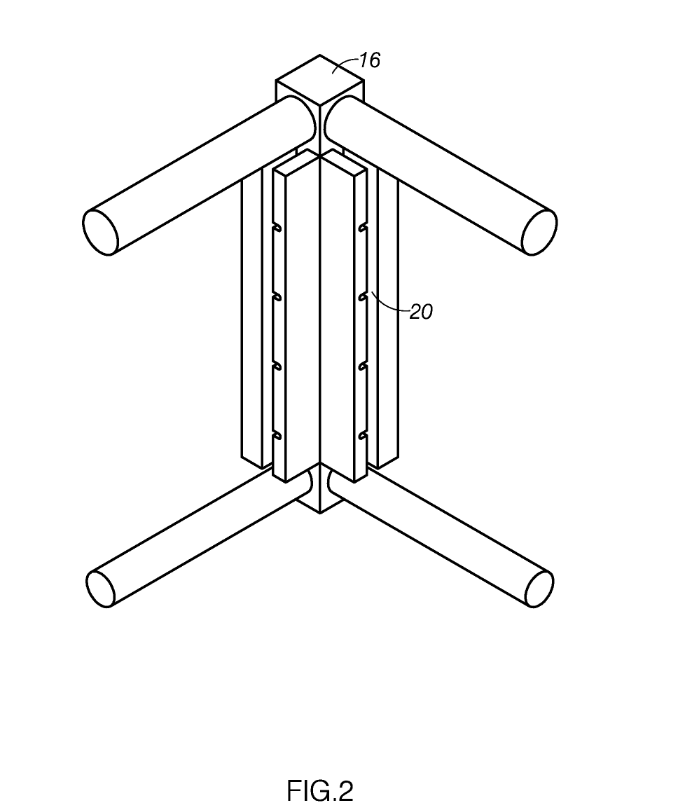

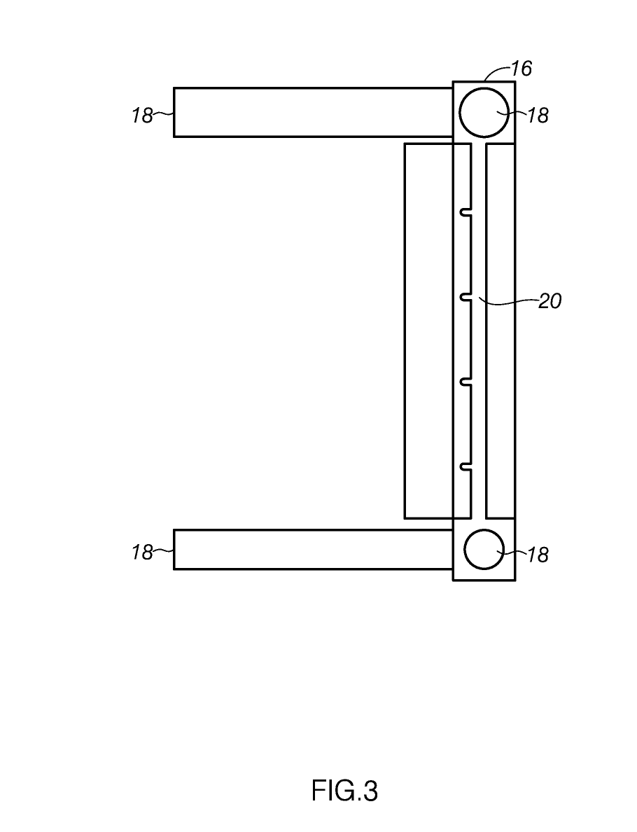

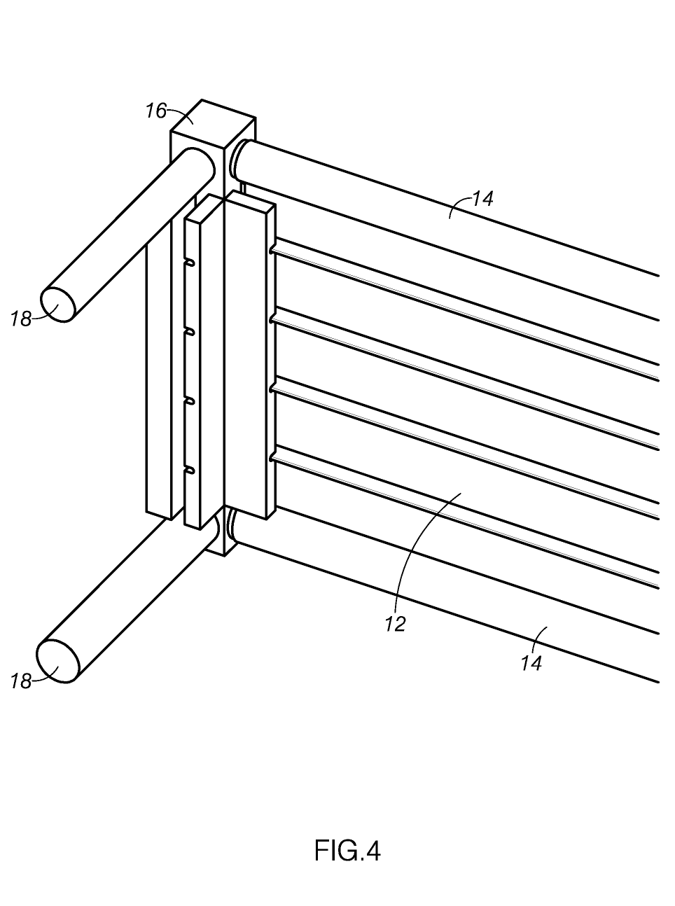

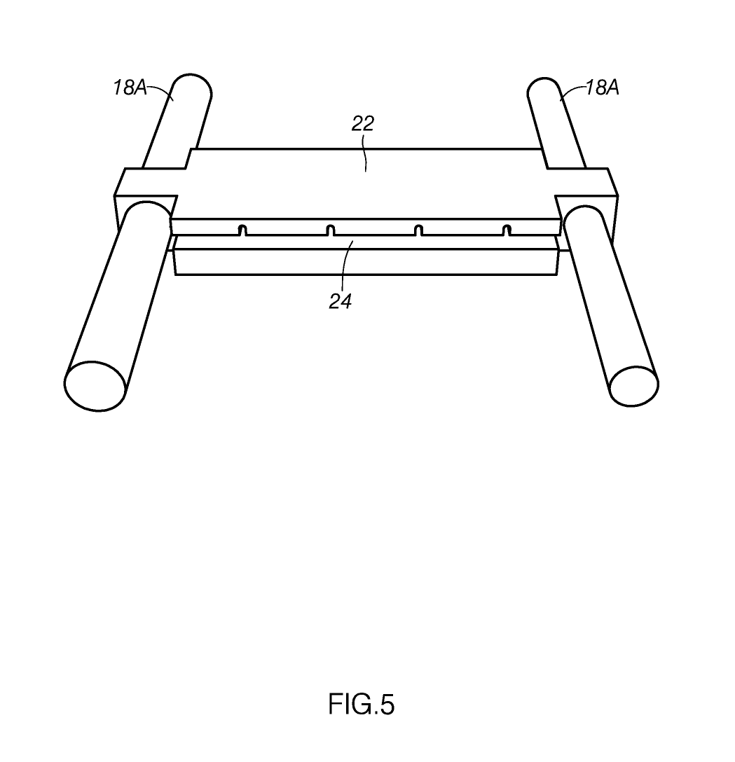

Referring to FIGS. 1 through 6, a raised bed garden system 10 can be designed as a rectangular raised bed garden system, as shown, however, other shapes can be envisioned within the scope of the present invention. For example, a square garden can be designed. With 60 degree corner coupling members, for example, a hexagonal shaped garden can be designed. Arc-shaped side panels may be coupled to form round or oval shaped raised bed garden systems.

The garden system 10 can be formed from a plurality of panel members 12 that can be made from a rigid or semi-rigid polymeric or composite material, for example. Other materials may also be contemplated within the scope of the present invention. The panel members 12 can be from about 6 to about 20 inches high, for example, and can include at least two hollow receptacle portions 14 running along their length, typically located at least on the top and bottom of the panel members 12. Of course, the panel members 12 could be as short or as tall as may be desired and panel members 12 shorter than 6 inches and taller than 20 inches are both contemplated within the scope of the present invention. While the Figures show the receptacle portions 14 at the top and bottom of the panel members, such receptacle portions 14 may also be present along a mid-section of the panel members 12. Such embodiments may be useful when the panel members 12 are tall, for example, when the panel members 12 are over 12 inches tall. While the Figures show the receptacle portions 14 being of different sizes, these could be designed as the same size if desired.

A corner coupling member 16 can join together two panel members 12 at an angle. The corner coupling member 16 includes two insertion members 18 that fit inside the hollow receptacle portions 14 of the panel members 12. The body of the corner coupling member 16 can include slots 20 along each side to receive the sides of the panel members 12 therein. The slots 20 may be shaped to receive the panel members 12. For example, if the panel members 12 are ribbed, as shown, the slots 20 may have tabs to receive the ribs. The insertion members 18 of the corner coupling member 16 can be made from various materials, including plastic, composite, metal, or the like.

While the Figures show the corner coupling members 16 being disposed with the solid insertion members 18 extending out at 90 degree angles, other angles are contemplated within the scope of the present invention. For example, corner coupling members can be provided with a 45 degree angle to create an octagon shaped raised bed garden.

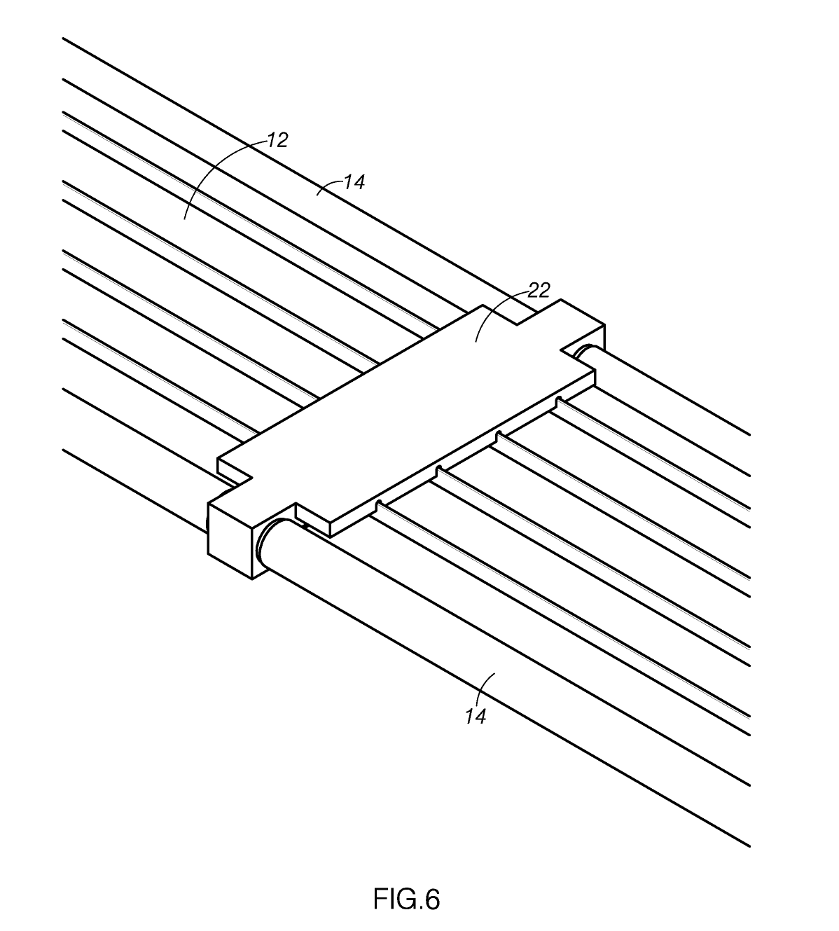

A straight coupling member 22 can include two insertion members 18A that fit inside the hollow receptacle portions 14 of the panels. The body of the straight coupling member 22 can include slots 24 along each side to receive the sides of the panel members 12 therein, as shown in FIG. 6. The insertion members 18A of the straight coupling member 22 can be made from various materials, including plastic, composite, metal, or the like.

While the Figures show a hollow receptacle portion (female receptacle) on the upper and lower ends of the panel members and insertion members fitting therein on the coupling members, this design may be reversed, where the panel members have insertion members that may fit into hollow receptacle portions formed in the coupling members.

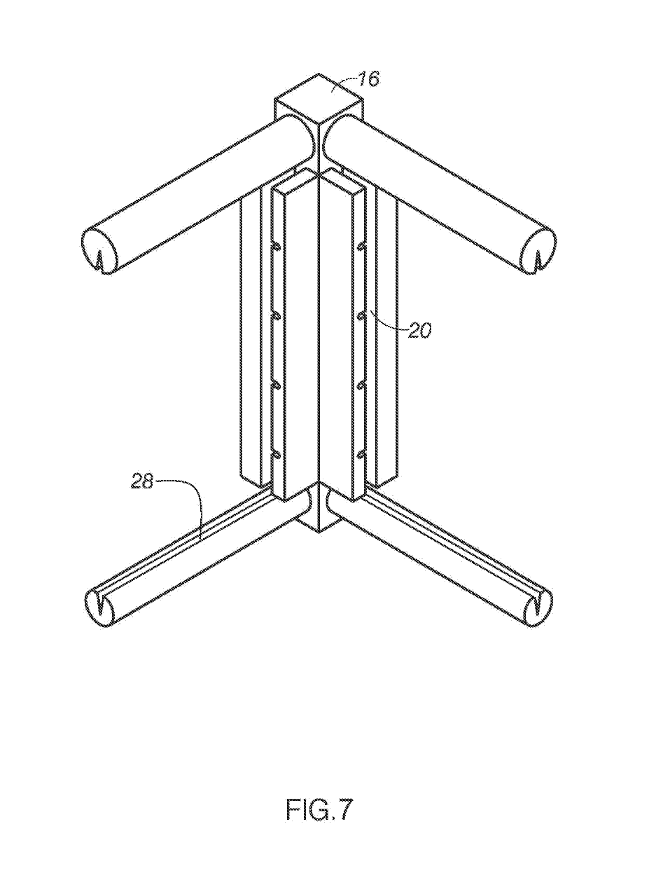

While the Figures show the receptacle portion and the insertion members as having round cross-sections, the size and shape of these features may vary within the scope of the present invention. For example, the receptacle portion may be a slot into which a flat, bar-shaped insertion member fits. As another example, the receptacle portion may be square with a square shaped insertion member. Other geometrical and non-geometrical shapes can be used for these features. In some embodiments, as shown in FIG. 7, for example, the insertion members 18 can include a cut-out 28 running along its length. This cut-out 28 may receive a protrusion (not shown) formed in the receptacle portion of the panel members.

In some embodiments, the coupling members could be designed with a pin on one end and a tab on the other end, where the coupling members could be stacked on top of each other, fitting together to prevent side-to-side motion, to create a raised bed garden having a height twice that of the panel height. A similar pin and tab construction could be incorporated into the panel members 12 to permit stacking thereof to create a raised bed garden having a height twice that of the panel height. Additional panel members may be stacked to further add to the height of the raised garden system, as may be desired. This feature also permits the raised garden system to be installed on a sloping grade, where one or more sides may be built higher than other sides to provide a taller wall on one or more sides of the raised garden.

In some embodiments, one end of the coupling members could include an elongated pin or post that can be inserted into the ground to help secure the raised bed garden in place. Other securing mechanisms may be included within the scope of the present invention. For example, an eye may be formed along a bottom edge of the panel members 12. The eye could receive a stake to secure the panel member 12 to the ground.

The coupling members can be shaped, contoured and colored to match the panel design or, in some embodiments, be designed to distinguish from the panel design.

In some embodiments, the raised garden system of the present invention may be provided with a liner or other such containment system that may attach to the panel members and/or the coupling members to create a planting pot type of structure.

In some embodiments, especially in those embodiments where the panels may be greater than 8 inches wide, one or more centrally located hollow insertion members can be formed along the length of the panels. For example, a third hollow insertion member can be formed along the length of the panel. In this embodiment, the coupling members, including the straight and corner coupling members, can be formed with three solid insertion members that fit into the three hollow insertion members of the panels.

While the above description refers to raised bed garden design, the system of the present invention could be used for other purposes. For example, with an appropriate liner the structure of the present invention could be used for a water garden or fish pond. The system of the present invention can be used for other purposes as well, for example, to help corral together plant pots to prevent wind from blowing away a single pot.

It should be understood, of course, that the foregoing relates to exemplary embodiments of the invention and that modifications may be made without departing from the spirit and scope of the invention as set forth in the following claims.

What is claimed is:

1. A raised bed garden system comprising:
a plurality of side panels;
receptacle portions disposed along at least an upper edge and a lower edge of the plurality of side panels;
coupling members joining adjacent ones of the plurality of side panels, the coupling members including insertion members extending from each side thereof at an upper side and a lower side thereof, wherein
the insertion members of the coupling members fit into the receptacle portions of the plurality of side panels to securely join the adjacent ones of the side panels.

2. The raised bed garden system of claim 1, wherein the coupling members include corner coupling members forming an angle between the adjacent ones of the side panels.

3. The raised bed garden system of claim 2, wherein the angle is 90 degrees.

4. The raised bed garden system of claim 1, wherein the coupling members include straight coupling members joining the adjacent ones of the side panels in a substantially straight line.

5. The raised bed garden system of claim 1, wherein the insertion members on the upper side of the coupling members have a diameter different from the insertion members on the lower side of the coupling members.

6. The raised bed garden system of claim 1, further comprising slots on ends of the coupling members, wherein the slots received at least a portion of the side panels therein.

7. The raised bed garden system of claim 1, wherein the insertion members include a cut-out running along its length.

8. A raised bed garden system comprising:
a plurality of side panels;
receptacle portions disposed along at least an upper edge and a lower edge of the plurality of side panels;
corner coupling members joining adjacent ones of the plurality of side panels at an angle, the corner coupling members including insertion members extending from each side thereof at an upper side and a lower side thereof; and
straight coupling members joining adjacent ones of the plurality of side panels in a substantially straight line, the corner coupling members also including insertion members extending from each side thereof at a straight coupling member upper side and a straight coupling member lower side thereof, wherein
the insertion members of the straight and the corner coupling members fit into the receptacle portions of the plurality of side panels to securely join the adjacent ones of the side panels.

9. The raised bed garden system of claim 8, wherein the angle is 90 degrees.

10. The raised bed garden system of claim 8, wherein the insertion members on the upper side of the corner and the straight coupling members have a diameter different from the insertion members on the lower side of the corner and the straight coupling members.

11. The raised bed garden system of claim 8, further comprising slots on ends of the coupling members, wherein the slots received at least a portion of the side panels therein.

12. The raised bed garden system of claim 8, wherein the side panels include straightening ribs along a length thereof.
